(19) United States
(12) Patent Application Publication
(10) Pub. No.: US 2003/0080481 A1
(43) Pub. Date: May 1, 2003

(54) Air supply apparatus for a vehicle

(76) Inventor: Xu Wang, Garbsen (DE)

Correspondence Address: Walter Ottesen, Patent Attorney, P.O. Box 4026, Gaithersburg, MD, 20885-4026, US

(21) Appl. No.: 10/279,976

(22) Filed: Oct. 25, 2002

(30) Foreign Application Priority Data
Oct. 25, 2001 (DE) 101 52 153.7

(51) Int. Cl. F16F 9/43

(52) U.S. Cl. 267/64.28

(57) ABSTRACT

The invention is directed to an air supply apparatus for a vehicle having pneumatic equipment such as air springs. The air supply apparatus includes a compressor and a muffler. The muffler (3) includes one or several hoses (11, 16, 17, 19, 20, 23, 24) of rubber or a rubber-like material and is subdivided in its interior into several chambers (15) by throttle positions (14).

### FIELD OF THE INVENTION

The invention relates to an air supply apparatus for a vehicle having a pneumatic system which, for example, includes air springs. The air supply apparatus includes a compressor and a muffler.

### BACKGROUND OF THE INVENTION

German patent publication 198 35 491 discloses a pneumatic arrangement for a vehicle in the form of a level control system which includes air springs. In level control systems of this kind for controlling the level of a vehicle, air must be discharged from the air springs or the springs must be filled by means of the compressor. The air is usually conducted through an air dryer. Most important, the discharge of the air is associated with the development of a loud unpleasant noise. Accordingly, there is a requirement to equip level control systems of this kind with mufflers.

An air supply apparatus is disclosed in German patent publication 101 21 582 which includes a muffler which has several chambers arranged one behind the other and which are connected to each other by diffuser-type constricting channels. Furthermore, porous plates are provided through which the air is conducted. These plates are, for example, made of sintered material having a plurality of fine channels. A significant reduction in noise can be achieved with this air supply apparatus. The muffler, however, has the disadvantage that it requires a certain minimum diameter and a minimum length. In many modern vehicles, the space for components is so tight that it is difficult to accommodate the muffler because of its volume. In addition, the manufacture of the muffler is complex because it has a complicated structure in its interior and is assembled from a plurality of individual parts such as the diffusers.

### SUMMARY OF THE INVENTION

In view of the above, it is an object of the invention to provide an air supply apparatus of the above kind, which includes a muffler which can be mounted in the vehicle even under very tight space conditions and can be manufactured in a simple manner.

The air supply apparatus of the invention is for a vehicle equipped with a pneumatic system and includes: a compressor operatively connected to the pneumatic system for supplying the pneumatic system with compressed air; a muffler connected to the air supply apparatus through which air flows in a flow direction to or from the pneumatic system; the muffler including at least one hose segment made of rubber or a rubber-like material; and, the hose segment defining an interior and having a plurality of throttle positions formed in the interior to partition the interior into a plurality of chambers.

In contrast to the mufflers known to date, the muffler of the air supply apparatus of the invention omits baffle plates, sintered discs and foam fillings and the like which prevent an unrestricted air discharge and an unrestricted air intake. In this way, the air discharge noise of the air supply apparatus is not significantly longer than in an air supply apparatus entirely without a muffler. Furthermore, the occurring resistance which the compressor must overcome during intake and discharge is significantly less than in conventional mufflers.

The muffler is an air discharge hose which does not require its own housing. The problem of space, which is always present in damping measures, is thereby overcome. The hose has a lesser diameter than known mufflers. Because of its flexibility, the muffler of the invention can be placed in practically any desired position in the vehicle. In this way, the muffler can be mounted in the vehicle even under the most unfavorable circumstances. The muffler is built up from very simple parts. The manufacture as well as its assembly on the air supply apparatus are possible in a simple manner. Components can be used, which are standard and available in the marketplace.

The hose can, for example, be produced with the injection molding process. The throttle locations can be formed as one piece in the hose by placing a correspondingly configured core therein. This embodiment of the invention is advantageous when the muffler is to be produced in large numbers. The muffler is produced as one piece and additional work steps such as assembly of individual parts are unnecessary.

According to another advantageous embodiment of the invention, the muffler is assembled from several hose segments which are connected to each other by connecting pieces. The connecting pieces additionally assume the function of the throttle locations. This embodiment of the invention is especially advantageous when the muffler is needed in only reduced numbers because standard individual parts can be used rather than especially made individual parts.

In the air supply apparatus of the invention, a reduction of the discharge noise, but also the intake noise and knocking noises of the compressor, by at least 7 dBA can be achieved with the muffler. The noise attenuation is effected, on the one hand, by the throttle locations whereat the noise energy is swirled and converted to heat especially when there is a short-term, very intensive air throughflow when discharging air from the system. On the other hand, the soft material of the hose is attenuating. In comparison to the known air supply apparatus mentioned initially herein which has a muffler comprising hard components, the air supply apparatus of the invention not only achieves a better noise reduction, but the remaining noise is also more tolerable and less intense. A high quality of the noise attenuation can be achieved via suitable characteristics of the material of the hose. It has been shown that an especially good attenuation can be achieved when the hose has a Shore hardness between 70 and 80, preferably approximately 75 (given in Shore A).

As a third significant effect for the noise reduction in accordance with the invention, the reflections in the chamber lead to extinguishing the noise via phase-shifted, reflected sound waves of like frequencies. In order to optimally use this effect, the chambers are so configured in an advantageous embodiment of the invention that their lengths are in a whole-number ratio to the wavelength of those components of the noise which are primarily to be attenuated. The muffler can thereby be optimized by the selection of suitable dimensions. These dimensions are, however, dependent upon the noises to be attenuated and therefore on the additional components of the air supply apparatus, especially, of the compressor. Furthermore, a significant reduction of low frequencies (up to approximately 1000 Hz) is effected because these sound waves cannot propagate because their wavelength is greater than distances between the throttle positions.

In an advantageous embodiment of the invention, the muffler comprises a hose wherein the chambers are arranged one behind the other so that the air flows through the chambers one after the other. Such an embodiment of the invention affords the advantage that it is especially simple and has an especially slim muffler.

In another embodiment of the invention, the muffler has two or several mutually parallel hoses at its mid section. This embodiment affords the advantage of an especially short and compact configuration. In a muffler of this configuration, the air flow is subdivided into parallel flows and is again joined after a certain distance. The sound waves propagate in the parallel hoses and superpose one another at the location where they are brought together again and this causes the extinguishment of phase-shifted sound waves of the same frequency. In this muffler, two or more chambers are arranged parallel to each other. The branching positions can be simultaneously configured as throttle positions. This muffler is especially easy to manufacture in the above-described manner from several hose sections and connecting pieces. The connecting pieces define branchings.

### BRIEF DESCRIPTION OF THE DRAWINGS

The invention will now be described with reference to the drawings wherein:

FIG. 1 is a schematic of a level control system for a vehicle incorporating an air supply apparatus according to the invention;

FIG. 2 is an elevation view, in longitudinal section, of a muffler for the air supply apparatus shown in FIG. 1;

FIG. 3 is an elevation view, in longitudinal section, of a second embodiment of the muffler; and,

FIG. 4 is an elevation view, in longitudinal section, of a third embodiment of a muffler.

### DESCRIPTION OF THE PREFERRED EMBODIMENTS OF THE INVENTION

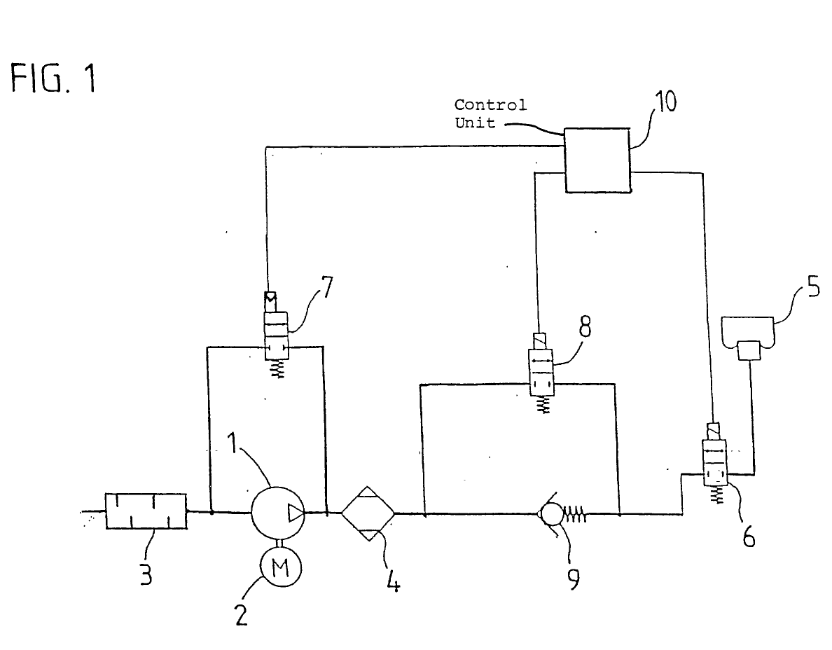

FIG. 1 shows a level control system, which includes an air supply apparatus. The air supply apparatus includes a compressor 1 driven by a motor 2 as well as a muffler 3 and an air dryer 4. The pneumatic elements, which are to be supplied with air by the air supply apparatus, are air springs 5, of which only one is shown for reasons of clarity. A valve 6 is connected ahead of each air spring 5 and the individual air springs 5 are individually controlled by the valve 6 corresponding thereto. Additional valves 7 and 8 as well as a check valve 9 are provided in the level control system. The valves 6, 7 and 8 are actuated electromagnetically and can be controlled by an electronic control unit 10.

The discharge or intake of air can, for example, function for the level control of a vehicle. In order to fill the compressed air system with air, the compressor 1 draws air from the ambient by suction via the muffler 3 and moves the air through the air dryer 4 and the check valve 9 and via the valves 6 to the air springs 5 when the valves 6 are in their pass-through position. The check valve 9 ensures that the air is received unhindered in the system but can be discharged only in a controlled manner via the valve 8. The valves 6, 7 and 8 are opened to discharge air from the system. The compressor 1 is bypassed by the valve 7 when discharging takes place in the air supply apparatus. The air then flows through the air dryer 4 and the muffler 3 in the reverse direction and reaches the ambient. With this configuration of the system, it is ensured that an attenuation of noise takes place during inflow of air to the system as well as during discharge of air from the system. In addition, the air is conducted always via the air dryer 4. The air is dried during inflow into the system and, during outflow from the system, the moisture, which is retained in the air dryer 4, is discharged to the ambient.

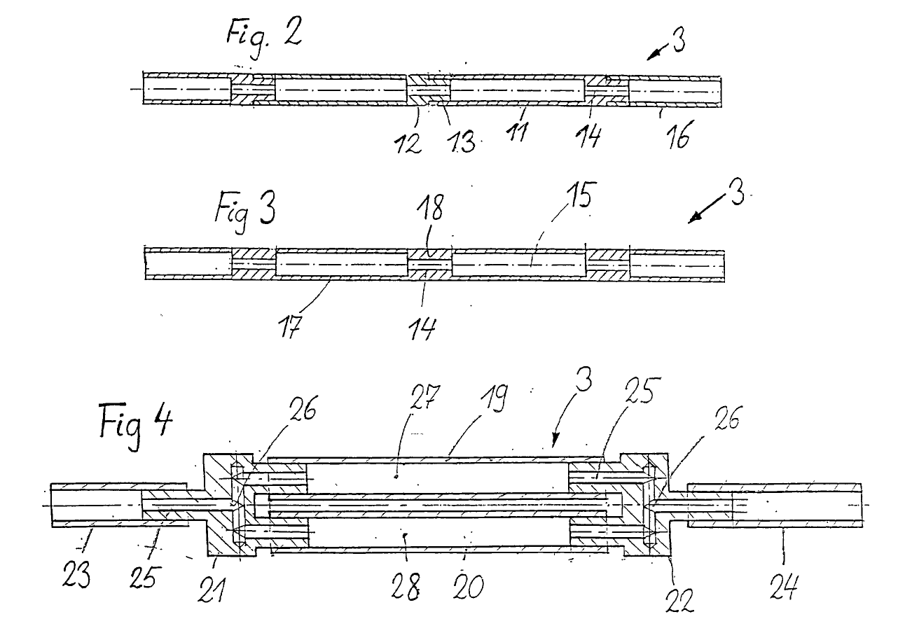

The muffler 3 will now be explained in greater detail with respect to the embodiments thereof shown in FIGS. 2 to 4.

The muffler of FIG. 2 comprises individual cylindrical hose segments 11 made of rubber, for example, NBR (acrylonitrile butadiene rubber) or ACM (acrylate elastomer) having a shore hardness of 75. The hose segments 11 are open at one end and have connecting pieces 12 at the other end. The connecting pieces each have an extension 13 toward the free end thereof having a reduced diameter and the extension is seated in the open end of the next adjacent hose segment 11. The connecting pieces 12 are formed on the respective hose segments 11.

Alternatively, the connecting pieces 12 can be manufactured separately and connected to the hose segments 11. Bores 14 extend through the connecting pieces 12 and extend primarily in the longitudinal direction of the muffler. The diameter of the bores 14 is significantly less than the inner diameter of the hose segment 11 so that the throttle positions are formed. When assembled, the hose segments 11 define a hose which has several chambers 15 in its interior and these chambers are arranged one behind the other and are separated from each other by the throttle positions 14. This hose is further provided with a hose segment 16 at its one end, which has no connecting piece 12 so that the hose is open at both ends. The one end of the hose is connected to the air supply apparatus, while the other end communicates with the ambient (FIG. 1) so that air, which is taken up by the air supply apparatus or outputted is passed through the hose.

The muffler of FIG. 3 is similar in its function to the muffler shown in FIG. 2. The muffler of FIG. 3 is, however, not assembled from individual segments. Instead, the muffler of FIG. 3 comprises a single hose 17 of rubber, which has inwardly extending projections 18 which define throttle positions 14. The projections 18 are integral with the hose 17. Chambers 15 are formed between the throttle positions 14. Such a muffler can, for example, be manufactured in a form having a core for the configuration of the structures in the interior of the hose 17.

In the mufflers of FIGS. 2 and 3, the chambers 15 can be approximately twice as long than the throttle positions 14 and the inner diameter of the hose 17 or of the hose segments 11 and 16 is approximately twice as large as that of the throttle positions 14. Typical dimensions for a model having three throttle positions are, for example, overall length: 200 mm; length of the chambers: 40 mm; diameter of the chambers: 10 mm; diameter of the throttle positions: 4.5 mm; and, wall thickness of the hose: 2 mm.

In the embodiment shown in FIG. 4, two hose sections 19 and 20 are arranged parallel to each other. Connecting pieces 21 and 22 are seated in their respective ends. The connection of the muffler to the air supply apparatus as well as the output thereof to the ambient takes place via hose segments 23 and 24, which likewise are pushed upon the end pieces 21 and 22, respectively. The connecting pieces 21 and 22 have channels for guiding the air and these channels branch at 26. The diameter of the channels 25 is less than the inner diameter of the hose segments. The connecting pieces 21 and 22 therefore function simultaneously as throttle positions. The hose segments 19 and 20 define respective chambers 27 and 28 which are arranged parallel to each other. The hose segments 19, 20, 23 and 24 are made of rubber, for example, NBR or acrylate elastomer. The connecting pieces can be made of plastic such as polyamide.

In the muffler, the air coming from the hose segment 23 is divided in branch 26 in the connecting piece 21 into two parallel flows, which are guided in the hose segments 19 and 20 and are brought together again in the second connecting piece 22. The noise propagates along the same path. At the branching 26 in the first connecting piece 21, the sound is subdivided into two fronts, which are superposed in the second connecting piece 22, so that they partially mutually extinguish each other.

It is understood that the foregoing description is that of the preferred embodiments of the invention and that various changes and modifications may be made thereto without departing from the spirit and scope of the invention as defined in the appended claims.

What is claimed is:

1. An air supply apparatus for a vehicle equipped with a pneumatic system, the air supply apparatus comprising:
a compressor operatively connected to said pneumatic system for supplying said pneumatic system with compressed air;
a muffler connected to said air supply apparatus through which air flows in a flow direction to or from said pneumatic system;
said muffler including at least one hose segment made of rubber or a rubber-like material; and,
said hose segment defining an interior and having a plurality of throttle positions formed in said interior to partition said interior into a plurality of chambers.

2. The air supply system of claim 1, wherein said chambers are arranged one behind the other in said flow direction.

3. The air supply system of claim 1, wherein sound is generated as a consequence of the flow thereof and said sound has a component which is to be attenuated the most by said muffler and said component has a wavelength; and, each of said chambers has a length which is a whole-number multiple of said wavelength of said component.

4. The air supply system of claim 1, wherein said muffler comprises at least two of said segments and a mid section connecting said two segments; and, said mid section includes two hose segments connected in parallel to each other.

5. The air supply system of claim 1, wherein said throttle positions are formed as integral parts of the segment.

6. The air supply system of claim 1, wherein said muffler comprises a plurality of said segments and a plurality of connecting pieces for connecting said segments one to the other.

7. The air supply system of claim 1, wherein said hose segments have a Shore-A-Hardness in the range of 60 to 80.

8. The air supply system of claim 7, wherein said hose segments have a Shore-A-Hardness of approximately 75.

9. An air supply apparatus for a vehicle equipped with a pneumatic system, the air supply apparatus comprising:
a compressor operatively connected to said pneumatic system for supplying said pneumatic system with compressed air;
a muffler connected to said air supply apparatus through which air flows in a flow direction for said pneumatic system;
said muffler including a plurality of hose segments made of rubber or a rubber-like material; and,
each of said hose segments having an interior defining a chamber having a diameter;
a plurality of connecting pieces for connecting said hose segments one to the other;
each one of said connecting pieces defining a throttle connecting the chambers of each two of the hose segments connected by the connecting piece; and,
the throttle of the connecting piece having a diameter less than said diameter of the chambers.

10. The air supply system of claim 9, wherein said hose segments have a Shore-A-Hardness in the range of 60 to 80.

11. The air supply system of claim 9, wherein said hose segments have a Shore-A-Hardness of approximately 75.
